(19) United States
(12) Patent Application Publication
(10) Pub. No.: US 2012/0313027 A1
(43) Pub. Date: Dec. 13, 2012

(54) RING SEAL FOR A CLOSING ELEMENT OF A VALVE AND SEAL ARRANGEMENT WITH SUCH A RING SEAL

(76) Inventors: Karl Welchner, Deiningen (DE); Frank Neuhauser, Neresheim (DE); Werner Deger, Kirchheim (DE); Michael Huebner-Hecker, Weil im Schoenbuch (DE); Andre Guetlein, Pliezhausen (DE); Erwin Seefried, Leonberg (DE); Florian Kargl, Donauworth (DE); Tilo Deichl, Leonberg (DE)

(21) Appl. No.: 13/416,361

(22) Filed: Mar. 9, 2012

Related U.S. Application Data
(63) Continuation of application No. PCT/EP2010/063163, filed on Sep. 8, 2010.

(30) Foreign Application Priority Data
Sep. 10, 2009 (DE) 10 2009 042 142.4

(51) Int. Cl. F16K 1/46; F16K 25/00

(52) U.S. Cl. 251/318; 277/549

(57) ABSTRACT

A ring seal for a closing element of a valve, in particular of a valve of a process engineering installation, a seal arrangement including the ring seal, and a valve including the seal arrangement. The ring seal has a ring body defining a longitudinal axis perpendicular to the plane of the ring body; a seal surface on a radially outer surface in relation to the longitudinal axis; and two substantially radially directed leg portions spaced apart from one another in the direction of the longitudinal axis. The two leg portions are connected to one another by a bridge portion extending in the direction of the longitudinal axis, on the radially outer surface of which bridge portion the sealing surface is provided; and, a radially inner surface of the bridge portion is spaced apart in the radial direction from ends of the leg portions which are remote from the sealing surface.

### CROSS REFERENCES TO RELATED APPLICATIONS

This application is a continuation of pending international patent application PCT/EP2010/063163, filed on Sep. 8, 2010 and designating the U.S., which international patent application has been published in German language and claims priority from German patent application 10 2009 042 142.4, filed on Sep. 10, 2009. The entire contents of these priority applications are incorporated herein by reference.

### BACKGROUND OF THE INVENTION

The invention relates to a ring seal for a closing element of a valve, in particular of a valve of a process engineering installation.

The invention furthermore relates to a seal arrangement on a closing element of a valve, in particular of a valve of a process engineering installation.

The invention also relates to a valve, in particular a valve for a process engineering installation.

Within the context of the present invention, a process engineering installation is for example a food processing plant, a chemical engineering installation, a pharmaceutical installation or the like.

A ring seal, a seal arrangement and a valve are known for example from DE 10 2007 038 124 A1.

The afore-mentioned document describes a double-seat valve for separating media in a food processing plant. The double-seat valve has two closing elements, specifically one closing element designed as a valve disk and one closing element designed as a closing sleeve.

Within the context of the present invention, the closing element may likewise be a valve disk or a closing sleeve.

In the known valve, the valve disk and the closing sleeve are assigned in each case one radially acting ring seal.

The respective ring seal on the respective closing element seals off against a closing element seat, which in the case of the known double-seat valve is formed by an inner surface of a cylindrical housing portion of the housing of the double-seat valve.

Corresponding to the function of the known double-seat valve, the valve disk and the closing sleeve are axially movable relative to the housing for the purpose of opening the valve or in order to lift one of the two closing elements for the purpose of cleaning the associated cleaning element seat. This means that the respective ring seal slides along the inner surface of the housing portion, which defines the closing element seat, during every stroke of the closing element. The ring seals are hereby subjected to shear forces which act in the direction of the longitudinal axis of the ring body of the ring seal. Furthermore, the ring seals are subjected to friction. Both the friction and also the shear forces lead to failure of the ring seal after a period of time.

In the known double-seat valve, the ring seals are formed as O-rings, and the groove for receiving the ring seal is of trapezoidal design in cross section, wherein the ring seal substantially completely fills out the groove and, in the state in which it is inserted into the groove, assumes a substantially trapezoidal form in cross section. Aside from ring seals formed as O-rings, ring seals are also known which already have a substantially trapezoidal form in cross section before being inserted into the groove.

In the case of such seal arrangements on closing elements of a valve of a food processing plant, it is necessary to prevent media, for example a product or a cleaning liquid, from passing under the ring seal and infiltrating into the groove. This requirement is met with the seal arrangement and the ring seal in the case of the known double seat valve.

A further technical problem which it has hitherto not been possible to satisfactorily solve with known seal arrangements and known ring seals is caused by the fact that the ring seal, which comes into contact with various media during operation of the valve, for example with product, cleaning liquid etc., tends to swell. The temperatures to which the ring seal is exposed also play a role here.

Ring seals are conventionally produced from a rigid elastomer, for example from different natural rubber types, perfluoroelastomers, polyethylene or PTFE.

As a result of the swelling of the ring body of the ring seal, the service life is disadvantageously reduced. This will be explained with reference to FIG. 1.

FIG. 1 shows a detail of a closing element 1, a closing element seat 2 and a ring seal 3 which is received in a groove 4 of the closing element 1. As illustrated, the ring seal 3 has approximately the shape of a trapezoid in cross section. A dashed line 5 shows the radially outer surface of the ring seal 3 when it is in the non-swollen state.

Since the ring seal 3 comes into contact with media during the operation of the valve, the ring seal 3 swells. A solid line 6 illustrates the radially outer surface of the ring seal 3 in the swollen state. As a result of the increase in volume of the material of the ring seal 3 owing to the swelling, a part of the material of the ring seal 3 now spreads into the gap 7 between the closing element 1 and the closing element seat 2, as shown by material portions 8a, 8b in FIG. 1. Said effect of the spreading of material of the ring seal 3 into the gap 7 is also referred to as gap extrusion.

Such gap extrusion reduces the service life of the ring seal 3 considerably. As the closing element 1 moves axially relative to the closing element seat 2, as indicated by a double arrow 9, the material portions 8a and 8b may tear off, as a result of which the sealing action of the ring seal 3 is reduced or even lost entirely. Here, the ring seal is subjected to particular loading at the opening edge 10 of the groove 4, at which the ring seal 3 can be sheared off as the closing element 1 moves relative to the closing element seat 2. The swelling effect of the ring seal 3 which leads to damage to the ring seal 3 is further intensified by the fact that, as is shown in FIG. 1 by the solid line 6, the contact area of the radially outer surface of the ring seal 3 against the closing element seat 2 is enlarged, as a result of which the friction of the radially outer surface of the ring seal 3 against the closing element seat 2 is correspondingly increased. The friction is also a cause of wear of the ring seal 3.

To avoid the disadvantages stated above, efforts have hitherto been made to seek materials for the ring seals which have a lesser tendency or even no tendency to swell. These efforts have however hitherto been unsuccessful, and there is therefore still a demand for an improved seal arrangement and an improved ring seal of the type mentioned in the introduction.

### SUMMARY OF THE INVENTION

It is therefore an object of the invention to improve a ring seal and a seal arrangement of the type mentioned in the introduction such that the service life of the ring seal is less adversely affected by swelling of the material of the ring seal.

According to an aspect of the invention, a ring seal for a closing element of a valve is provided, comprising a ring body having a longitudinal axis perpendicular to a plane of the ring body and having a radially outer surface in relation to the longitudinal axis, a sealing surface on the radially outer surface of the ring body, the ring body further having two leg portions directed substantially radially with respect to the longitudinal axis, the two leg portions being spaced apart from one another in direction of the longitudinal axis and having ends, and a bridge portion connecting the two leg portions to one another, the bridge portion extending in direction of the longitudinal axis and having a radially outer surface having the sealing surface, and a radially inner surface spaced apart in radial direction from the ends of the leg portions, the ends being remote from the sealing surface.

According to another aspect of the invention, a seal arrangement on a closing element of a valve is provided, comprising a ring seal having a ring body defining a longitudinal axis perpendicular to a plane of the ring body and having a sealing surface on a radially outer surface in relation to the longitudinal axis, a radial groove arranged on the closing element for receiving the ring seal, the groove having a groove base and groove flanks, the ring body having two substantially radially directed leg portions spaced apart from one another in direction of the longitudinal axis, the two leg portions being connected to one another by a bridge portion extending in direction of the longitudinal axis, the two leg portions having ends, the bridge portion having a radially outer surface having the sealing surface, and a radially inner surface radially spaced apart from the ends of the leg portions, the ends being remote from the sealing surface, the ends of the leg portions being supported on the groove base, and surfaces of the leg portions which are, in direction of the longitudinal axis, on outer sides of the leg portions bear against the groove flanks.

The invention is based on the concept not of preventing swelling of the ring seal through a corresponding selection of the material of the ring seal but rather of permitting swelling of the ring seal and eliminating the effects caused by the swelling which are detrimental to the service life of the ring seal by providing a geometry according to the invention which differs from the conventional geometry of ring seals. Specifically, the ring seal according to the invention has a space between the two leg portions and the bridge portion, which space allows the bridge portion to deflect into said space as the ring seal swells and allows material of the ring seal to yield into said space. The swelling of the ring seal thus no longer results in material of the ring seal infiltrating into the gap between the closing element and the closing element seat, but rather the ring seal in the groove can expand into the space provided according to the invention. The leg portions which are supported on the groove base ensure the radial support of the ring seal, whereas the bridge portion between the leg portions has a certain degree of resilient elasticity, which firstly allows the bridge portion to yield as the ring seal swells, and which secondly imparts the radial stress required for the sealing action against the closing element seat.

The leg portions, which bear against the groove flanks, of the ring body serve to fulfill the further requirement of ensuring that no medium infiltrates into the groove between the ring seal and the groove flanks.

It is thus possible for a conventional ring seal material, for example an elastomer, such as is already presently used for corresponding applications, to be used for the ring seal according to the invention.

In preferred embodiments of the seal arrangement, the groove flanks of the groove run radially or taper obliquely toward one another from radially outside to radially inside.

In both embodiments, the leg portions of the ring seal can bear intimately against the groove flanks, wherein if the groove flanks taper obliquely toward one another from radially outside to radially inside, the contact pressure is increased yet further, as a result of which medium is even more reliably prevented from infiltrating into the groove and from being able to pass under the seal.

In a further preferred embodiment of the seal arrangement, the groove, at its radially outer end, has a smaller dimension in the direction of the longitudinal axis than the ring seal when the latter is not inserted into the groove.

It is advantageous here that the axial contact pressure of the ring seal against the groove flanks is even greater, resulting in greater sealing against an infiltration of medium into the groove. Furthermore, the installation of the ring seal into the groove is simplified by virtue of the ring seal snapping into the groove when it is inserted into the latter. It is also advantageous that the ring seal is always situated in a defined installed position in the groove.

In a refinement of the abovementioned measure, the groove widens, proceeding from its radially outer end (opening edge), in the direction of the longitudinal axis over a radial partial extent which is smaller than the radial extent of the leg portions.

With this measure, the groove has, at is opening edge, a type of enclosure for the ring seal, which enclosure provides the abovementioned advantages, specifically the imparting of an adequate axial contact pressure of the leg portions against the groove flanks, simple installation by virtue of the ring seal snapping into the groove, and a defined installed position of the ring seal.

In a further preferred embodiment of the ring seal, those ends of the leg portions which are remote from the radially outer surface of the bridge portion are not connected to one another.

It is advantageous here that the ring seal as a whole is easy to produce.

In this case, it is preferably provided with regard to the seal arrangement that the groove base has a central radially outwardly elevated ridge which is spaced apart from the radially inner surface of the bridge portion and which fixes the two leg portions only in the direction of the longitudinal axis of the ring body.

Here, in conjunction with the abovementioned embodiment of the ring seal, it is advantageous for the elevated ridge provided on the groove base of the groove to fix the two leg portions in position in the axial direction, thereby ensuring that the leg portions always bear sealingly against the groove flanks and cannot bend away from the latter. Here, the ridge is spaced apart from the radially inner surface of the bridge portion, such that the yield space provided according to the invention is furthermore available in the event of swelling of the ring seal. Here, the web secures the leg sections only axially but not radially, as a result of which the insertion of the ring seal into the groove is very straightforward.

As an alternative to the abovementioned embodiment of the ring seal, those ends of the leg portions which are remote from the radially outer surface of the bridge portion may be connected to one another by a web which has a high level of stiffness in the direction of the longitudinal axis.

It is advantageous here that the groove base of the groove need not have the abovementioned elevated ridge, but rather may be of planar overall design. This contributes to a simplification of the production of the groove in the closing member. The web provided on the ring seal itself holds the ends of the leg portions against the groove flanks.

Further preferred embodiments which are advantageous both for the ring seal and also for the seal arrangement will be described below.

In one of said preferred embodiments, the sealing surface on the radially outer surface of the bridge portion is formed as a substantially linear sealing lip which encircles the longitudinal axis.

It is advantageous here that the sliding friction of the sealing surface of the ring seal as the closing element moves relative to the closing element seat is considerably reduced, which likewise contributes to a lengthening of the service life of the ring seal.

Here, it is furthermore preferable for the radially outer surface of the bridge portion to have a concavely shaped depression proceeding from the sealing lip in the direction of at least one of the leg portions.

As a result of the concave curvature extending preferably to both sides of the sealing lip, a further space is created into which material of the ring seal can spread as the ring seal swells, without said material coming into contact under pressure with the closing element seat, or even being pressed into the gap between the closing element and the closing element seat.

In a further preferred embodiment, the radially inner surface of the bridge portion merges into the leg portions with a curvature which is concave as viewed from the longitudinal axis.

Said embodiment has the advantage that, as a result of the concave curvature of the radially inner surface of the bridge portion, the bridge portion has an even greater degree of radial resilient elasticity, which presses the sealing surface on the bridge portion against the closing element seat with adequate pressure.

In a further preferred embodiment, a support element for supporting the bridge portion is arranged on the radially inner surface of the bridge portion.

The support element preferably has a different spring characteristic than the bridge portion and/or a different material than that of the bridge portion.

In said embodiment, the space between the leg portions and the radially inner surface is at least partially filled out by the support element. The support element is preferably selected so as to have a different spring characteristic and/or a different hardness than the bridge portion of the ring seal. For example, the support element may be composed of a softer material than that of the bridge portion, such that as the ring seal swells, the bridge portion can deflect radially inward while compressing said softer material, without any resulting gap extrusion effect or increased friction of the sealing surface on the sealing element seat. The provision of such a support element in the space between the bridge portion and the leg portions has the advantage of increasing the contact pressure of the sealing surface against the closing element seat at least in the non-swollen state of the ring seal. Furthermore, the space between the leg portions, the bridge portion and the groove base is preferably completely filled out by the support element, as a result of which a further demand on the ring seal is met if said ring seal is used in a valve for a food processing plant.

Further advantages and features will emerge from the following description and the appended drawing.

It is self-evident that the features mentioned above and the features yet to be explained below may be used not only in the respectively specified combination but rather also in other combinations or individually without departing from the scope of the present invention.

### BRIEF DESCRIPTION OF THE DRAWINGS

Exemplary embodiments of the invention are illustrated in the drawing and will be described in more detail below with reference thereto. In the drawing:

FIG. 1 shows a seal arrangement according to the prior art in a section parallel to the longitudinal axis of the seal arrangement;

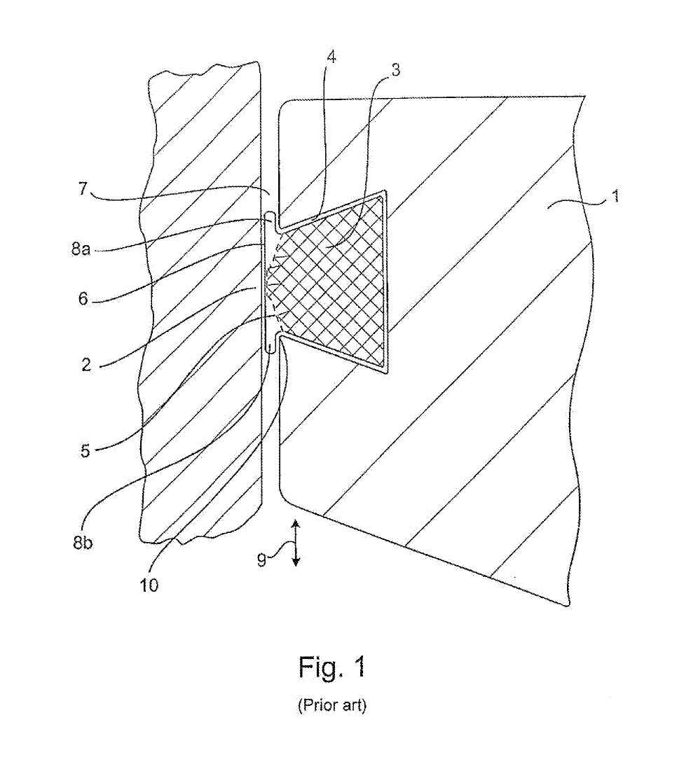

FIG. 2 shows a detail of a valve, in particular double-seat valve of a food processing plant, in a section parallel to the longitudinal axis of the valve, having a seal arrangement according to the invention and a ring seal according to the invention;

FIG. 3 shows a detail, enlarged in relation to FIG. 2, of the valve in FIG. 2;

FIG. 4 shows the ring seal of the seal arrangement in FIGS. 2 and 3 on its own in a perspective view;

FIG. 5 shows a ring seal according to a further exemplary embodiment in cross section parallel to the longitudinal axis of the ring seal; and

FIG. 6 shows yet a further exemplary embodiment of a ring seal in a cross section parallel to the longitudinal axis of the ring seal.

### DESCRIPTION OF PREFERRED EXEMPLARY EMBODIMENTS

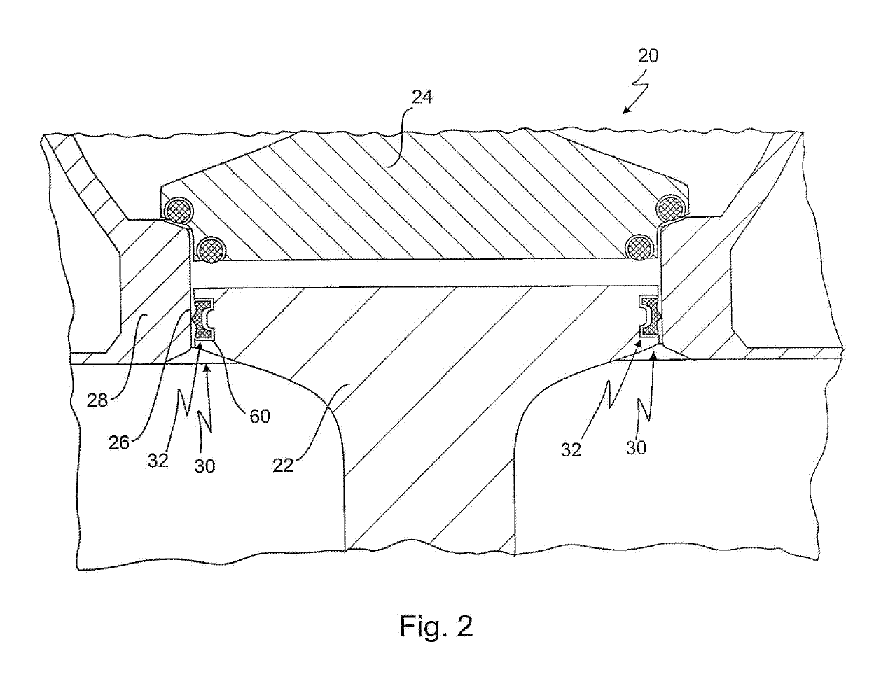

FIG. 2 shows a valve denoted generally by the reference numeral 20, which valve is designed for example as a double-seat valve and is used in a process engineering installation, for example a food processing plant.

The double-seat valve 20 has a first closing element 22 and a second closing element 24, wherein the closing elements 22 and 24 are shown here as valve disks.

In the closed position shown in FIG. 2, the closing element 22 interacts with a closing element seat 26 which is formed as a cylindrical surface on a housing portion 28 of the housing of the valve 20.

From the closed position shown in FIG. 2, the closing element 22 can be moved upward, as per an arrow 27, so as to drive the second closing element 24 into the open position. The closing element 22 could however also be moved downward, counter to the direction of the arrow 27, out of the closed position into its open position, for example for the purpose of lifting the closing element 22.

The closing element 22 has a seal arrangement 30 according to the invention which has a ring seal 32.

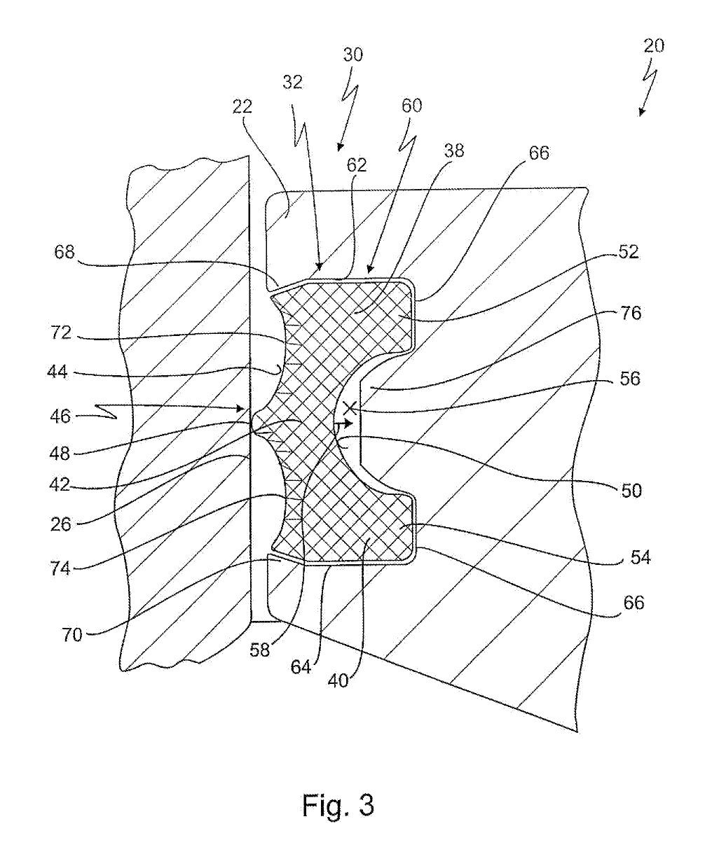

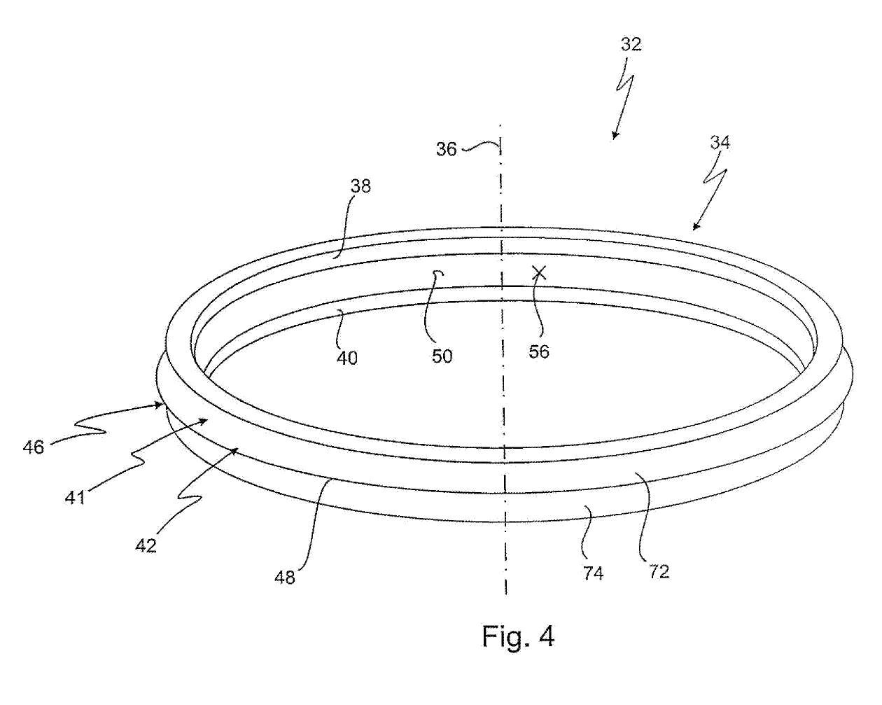

The seal arrangement 30 and the ring seal 32 will be described in more detail below, with reference also to FIGS. 3 and 4.

FIG. 4 shows the ring seal 32 on its own.

Corresponding to its installed position in the closing element 22 and its interaction with the closing element seat 26, the ring seal 32 is formed as a radial seal.

The ring seal 32 has a ring body 34 which defines a longitudinal axis 36 perpendicular to the plane of the ring body 34.

Where the expressions “radial” and “axial” are used below, these expressions relate to the longitudinal axis 36.

As per FIGS. 3 and 4, the ring body 34 has two substantially radially directed leg portions 38 and 40 which are spaced apart from one another in the direction of the longitudinal axis 36. The leg portions 38 and 40 are connected to one another by a bridge portion 42 which extends in the direction of the longitudinal axis 36. The leg portions 38, 40 and the bridge portion 42 are preferably integrally connected to one another and are preferably composed of the same seal material, for example a stiff elastomer.

The bridge portion 42 has a radially outer surface 44 which has a sealing surface 46. Here, the sealing surface 46 is formed as a substantially linear sealing lip 48 which encircles the longitudinal axis 36.

A radially inner surface 50 of the bridge portion 42 is spaced apart in the radial direction from ends 52 and 54 of the leg portions 38 and 40.

In this way, a space 56 is provided between the leg portions 38, 40 and the bridge portion 42, which space serves as a yield space for the volume expansion of the ring seal 32 as the ring seal 32 swells, that is to say into which space material of the ring seal 32 can yield as the latter swells. Furthermore, as a result of the geometric configuration of the ring body 34 with the two radial leg portions 38 and the axial bridge portion 42, the bridge portion 42 can deflect elastically into the space 56, as indicated by an arrow 58 in FIG. 3.

Here, as can be seen in particular from FIGS. 2 and 3, the radially inner surface 50 of the bridge portion 42 merges into the leg portions 38, 40 with a curvature which is concave as viewed from the longitudinal axis 36; the resilient action of the bridge portion 42 is dimensioned in this way.

The seal arrangement 30 furthermore has a groove 60 in which the ring seal 32 is received.

The groove 60 has a groove flank 62 which is assigned to the leg portion 38 and a groove flank 64 which is assigned to the leg portion 40. The groove flanks 62 and 64 delimit the groove 60 in the axial direction. In the radial direction, the groove 60 is delimited by a groove base 66. The ends 52 and 54 of the leg portions 38, 40 are supported in the radial direction on the groove base 66, while the axially outer surfaces of the leg portions 38, 40 bear areally against the groove flank 62 and the groove flank 64 respectively.

The groove flanks 62 and 64 preferably run radially as shown, though it may also be provided that the groove flanks 62 and 64 taper obliquely toward one another from radially outside to radially inside, as a result of which a preload in the axial direction can be imparted to the leg portions 38, 40.

The groove, at its radially outer end, more precisely at the radially outer end 68 of the groove flank 62 and at the radially outer end 70 of the groove flank 64, has a smaller dimension in the axial direction than the ring seal 32 when the latter is not inserted into the groove 60. Proceeding from the ends 68 and 70, the groove 60 widens over a radial partial extent which is smaller than the radial extent of the leg portions 38, 40, as shown in FIG. 3.

At their radially outer end, the leg portions 38 and 40 are therefore compressed slightly axially, resulting in particularly good sealing contact of the leg portions 38 and 40 against the groove flanks 62 and 64.

Furthermore, the axial projections on the outer ends 38 and 70 of the groove flanks 62, 64 have the effect that the ring seal 32 is snapped or latched into the groove 60 during assembly, and said outer ends define a predetermined installed position of the ring seal 32 in the groove 60.

The sealing lip 48 is arranged approximately centrally between the leg portions 38 and 40 in the axial direction, wherein the radially outer surface 44 of the bridge portion 42 has an in each case concavely shaped depression 72 and 74 proceeding from the sealing lip 48 toward both leg portions 38 and 40. In this way, too, additional yield space is provided for the ring seal 32 for a volume enlargement of the ring seal 32 as it swells, thereby preventing any further regions of the outer surface 44 of the bridge portion 42 aside from the sealing lip 48 from making contact, at least under high contact pressure, with the closing element seat 26. In particular, material of the ring seal 32 is thereby likewise prevented from passing into the gap between the closing element seat 26 and the closing element 22 as the ring seal 32 swells.

In the exemplary embodiment shown in FIGS. 3 and 4, the ends 52 and 54 of the leg portions 38 and 40 are not connected to one another. In this case, the groove base 66 has a central, radially outwardly elevated ridge 76. The ridge 76 serves to fix the two leg portions 38 and 40 in position in the direction of the longitudinal axis 36, that is to say the ridge 76 prevents the ends 52 and 54 or the leg portions 38 and 40 as a whole from bending away from the respective groove flank 62 and 64 and correspondingly losing contact with the groove flank 62 or 64.

The ridge 76 has a shape which fixes the ends 52 and 54 of the leg portions 38 and 40 in position only in the axial direction but not in the radial direction, that is to say the ends 52 and 54 of the leg portions 38 and 40 are not latched to the groove base 66 in the radial direction.

As already mentioned above, the entire ring seal 32 may be produced in one piece from a single material, for example from a rigid elastomer, wherein owing to the geometry of the ring seal 32, the swelling characteristics of such a material are not of primary importance. In the event of swelling of the ring seal 32, a volume yield space into which the ring seal 32 can expand is firstly provided by the space 56 between the leg portions 38 and 40 and the bridge portion 42, and furthermore a yield space of said type is provided on the radially outer side of the surface 44 by the depressions 72 and 74.

The ring seal 32 also satisfies the requirement that a medium, for example product or cleaning liquid, cannot infiltrate between the ring seal 32 and the groove 60 by passing under the ring seal 32. This is achieved firstly by the axial projections 68 and 70 at the inlet of the groove 60 and also by the ridge 76 on the groove base 66.

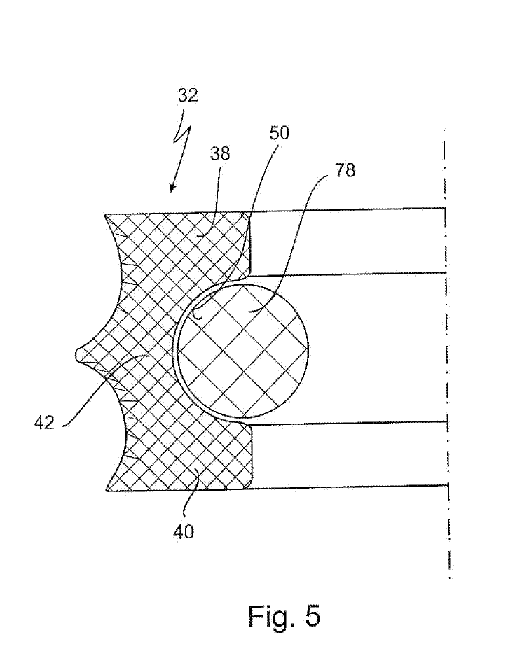

FIG. 5 shows a modification of the ring seal 32 in which a support element 78 for supporting the bridge portion 42 is arranged on the radially inner surface 50 of the bridge portion 42. The support element has a different spring characteristic than the bridge portion 42 and/or a different material than that of the bridge portion 42. Such a material may be for example foam rubber which is easily compressible. In this embodiment, the ring seal 32 may likewise be inserted into the groove 60 as per FIG. 3, wherein then the support element 78 is compressed between the radially inner surface 50 and the ridge 76, and the space 56 is completely filled out by the support element 78. Here, however, owing to the compressibility of the element 78, the space 56 is maintained as a yield space in the event of a volume expansion of the ring seal 32, wherein the support element 78 secondly increases the radial contact pressure of the sealing lip 48 against the closing element seat 26 and thereby ensures a high sealing action. The support element 78 may, as illustrated, be designed as an O-ring, and may be adhesively bonded or the like to the inner surface 50.

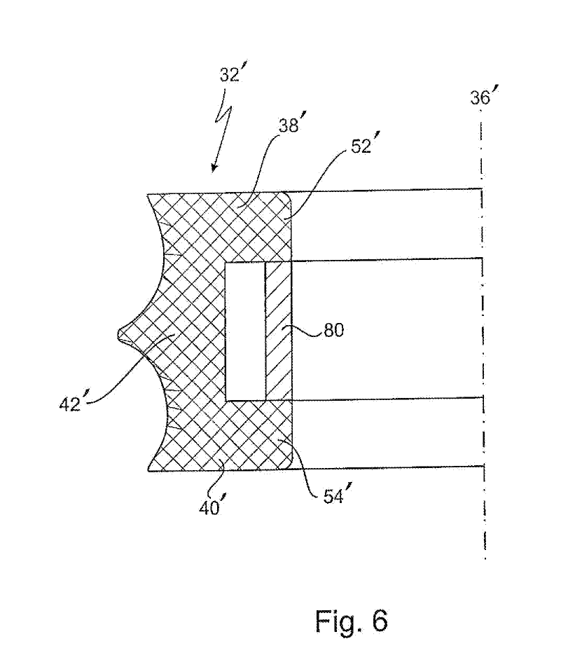

FIG. 6 shows a further modification of a ring seal 32′ in which, in contrast to the ring seal 32, the ends 52′ and 54′ of the leg portions 38′ and 40′ are connected to one another via a web 80 which has a high level of stiffness in the direction of the longitudinal axis 36′. In such an embodiment of the ring seal 32′, it is possible in the groove 60 in FIG. 3 for the ridge 76 to be omitted, wherein then the web 80 holds the leg portions 38′ and 40′ in contact with the groove flanks 62 and 64. Therefore, with such an embodiment of the ring seal 32′, the groove base 66 can be of planar design in the axial direction.

The web 80 may be formed in one piece with the leg portions 38′ and 40′ or cohesively connected thereto, for example by adhesive bonding.

What is claimed is:

1. A ring seal for a closing element of a valve, comprising
a ring body having a longitudinal axis perpendicular to a plane of the ring body and having a radially outer surface in relation to the longitudinal axis,
a sealing surface on the radially outer surface of the ring body,
the ring body further having
two leg portions directed substantially radially with respect to the longitudinal axis, the two leg portions being spaced apart from one another in direction of the longitudinal axis and having ends, and
a bridge portion connecting the two leg portions to one another, the bridge portion extending in direction of the longitudinal axis and having
a radially outer surface having the sealing surface, and
a radially inner surface spaced apart in radial direction from the ends of the leg portions, the ends being remote from the sealing surface.

2. The ring seal of claim 1, wherein the sealing surface on the radially outer surface of the bridge portion is formed as a substantially linear sealing lip which encircles the longitudinal axis.

3. The ring seal of claim 2, wherein the radially outer surface of the bridge portion has at least one concavely shaped depression proceeding from the sealing lip towards at least one of the leg portions.

4. The ring seal of claim 1, wherein the radially inner surface of the bridge portion merges into the leg portions with a curvature which is concave as viewed from the longitudinal axis.

5. The ring seal of claim 1, wherein the ends of the leg portions which are remote from the radially outer surface of the bridge portion are not connected to one another.

6. The ring seal of claim 1, wherein the ring body further has a web connecting the ends of the leg portions which are remote from the radially outer surface of the bridge portion to one another, the web being stiff in direction of the longitudinal axis.

7. The ring seal of claim 1, wherein a support element for supporting the bridge portion is arranged on the radially inner surface of the bridge portion.

8. The ring seal of claim 7, wherein the support element has a different spring characteristic than the bridge portion.

9. The ring seal of claim 7, wherein the support element has a different material than that of the bridge portion.

10. A seal arrangement on a closing element of a valve, comprising
a ring seal having a ring body defining a longitudinal axis perpendicular to a plane of the ring body and having a sealing surface on a radially outer surface in relation to the longitudinal axis,
a radial groove arranged on the closing element for receiving the ring seal, the groove having a groove base and groove flanks,
the ring body having two substantially radially directed leg portions spaced apart from one another in direction of the longitudinal axis, the two leg portions being connected to one another by a bridge portion extending in direction of the longitudinal axis, the two leg portions having ends, the bridge portion having a radially outer surface having the sealing surface, and a radially inner surface radially spaced apart from the ends of the leg portions, the ends being remote from the sealing surface,
the ends of the leg portions being supported on the groove base, and surfaces of the leg portions which are, in direction of the longitudinal axis, on outer sides of the leg portions bear against the groove flanks.

11. The seal arrangement of claim 10, wherein the groove flanks of the groove run radially with respect to the longitudinal axis.

12. The seal arrangement of claim 10, wherein the groove flanks of the groove taper obliquely toward one another from radially outside to radially inside.

13. The seal arrangement of claim 10, wherein the groove, at its radially outer end, has a smaller dimension in direction of the longitudinal axis than the ring seal when the ring seal is not inserted into the groove.

14. The seal arrangement of claim 13, wherein the groove widens, proceeding from a radially outer end of the groove, in direction of the longitudinal axis over a radial partial extent which is smaller than a radial extent of the leg portions.

15. The seal arrangement of 10, wherein the sealing surface on the radially outer surface of the bridge portion is formed as a substantially linear sealing lip which encircles the longitudinal axis.

16. The seal arrangement of claim 15, wherein the radially outer surface of the bridge portion has a concavely shaped depression proceeding from the sealing lip in the direction of at least one of the leg portions.

17. The seal arrangement of claim 10, wherein the radially inner surface of the bridge portion merges into the leg portions with a curvature which is concave as viewed in the radially outward direction.

18. The seal arrangement of claim 10, wherein the ends of the leg portions which are remote from the radially outer surface of the bridge portion are not connected to one another, and the groove base has a central radially outwardly elevated ridge which is spaced apart from the radially inner surface of the bridge portion and which fixes the two leg portions only in direction of the longitudinal axis of the ring body.

19. The seal arrangement of claim 10, wherein the ends of the leg portions which are remote from the radially outer surface of the bridge portion are connected to one another by a web which has a high level of stiffness in the direction of the longitudinal axis of the ring body.

20. The seal arrangement of claim 10, wherein a support element for supporting the bridge portion is arranged on the radially inner surface of the bridge portion.

21. The seal arrangement of claim 20, wherein the support element has a different spring characteristic than the bridge portion.

22. The seal arrangement of claim 20, wherein the support element has a different material than that of the bridge portion.

23. A valve, comprising a seal arrangement having
a ring seal having a ring body defining a longitudinal axis perpendicular to a plane of the ring body and having a sealing surface on a radially outer surface in relation to the longitudinal axis,
a radial groove arranged on the closing element for receiving the ring seal, the groove having a groove base and groove flanks,
the ring body having two substantially radially directed leg portions spaced apart from one another in direction of the longitudinal axis, the two leg portions being connected to one another by a bridge portion extending in direction of the longitudinal axis, the two leg portions having ends, the bridge portion having a radially outer surface having the sealing surface, and a radially inner surface radially spaced apart from the ends of the leg portions, the ends being remote from the sealing surface,
the ends of the leg portions being supported on the groove base, and surfaces of the leg portions which are, in direction of the longitudinal axis, on outer sides of the leg portions bear against the groove flanks.

24. The valve of claim 23, wherein the valve is used in a process engineering installation.
